(19) United States
(12) Patent Application Publication
(10) Pub. No.: US 2026/0045523 A1
(43) Pub. Date: Feb. 12, 2026

(54) SEPARATOR FOR FUEL CELL

(71) Applicants: Hyundai Motor Company, Seoul (KR); Kia Corporation, Seoul (KR)

(72) Inventors: Kyeong Cheol PARK, Hwaseong-si (KR); Kyeong Min KIM, Hwaseong-si (KR)

(21) Appl. No.: 18/969,655

(22) Filed: Dec. 5, 2024

(30) Foreign Application Priority Data
Aug. 12, 2024 (KR) 10-2024-0107327

(51) Int. Cl. H01M 8/026; H01M 8/0265

(52) U.S. Cl. CPC H01M 8/026; H01M 8/0265

(57) ABSTRACT

An embodiment separator for a fuel cell includes a land in contact with a gas diffusion layer, a gas flow channel configured to supply gas to the gas diffusion layer, wherein the land and the gas flow channel are repeatedly disposed in an alternating pattern in a width direction, partial narrow passages disposed at a predetermined interval in a longitudinal direction of the gas flow channel, the partial narrow channels being narrow compared to a width of the gas flow channel, and a water discharge guide groove with a lowered land height disposed at each of two lands of the partial narrow passages.

### CROSS-REFERENCE TO RELATED APPLICATIONS

This application claims the benefit of Korean Patent Application No. 10-2024-0107327, filed on August 12, 2024, which application is hereby incorporated herein by reference.

### TECHNICAL FIELD

The present disclosure relates to a separator for a fuel cell.

### BACKGROUND

A fuel cell system provided to a fuel cell vehicle, etc., includes a fuel cell stack configured to generate electrical energy, a fuel supply system configured to supply fuel (hydrogen) to the fuel cell stack, and an air supply system configured to supply oxygen in the air, which is an oxidant necessary for electrochemical reaction, to the fuel cell stack.

Referring to FIG. 1 for the cell unit configuration of a fuel cell stack, a membrane-electrode assembly is located at the innermost position, and this membrane-electrode assembly includes a polymer electrolyte membrane 10 configured to move protons, and a cathode 12 and an anode 14, which are catalyst layers applied onto respective sides of the electrolyte membrane to enable hydrogen and oxygen to react.

In addition, a gas diffusion layer (GDL) 16 and a gasket 18 are sequentially stacked on the outer surface of each of the cathode 12 and the anode 14, and a separator 20 having gas flow passages for supplying and discharging fuel (hydrogen) and an oxidant (air) and coolant flow passages for supplying and discharging coolant is stacked on the outer surface of each gas diffusion layer 16.

In addition, end plates 30 are attached to the outermost surfaces of the fuel cell stack to fix cell unit components at a predetermined surface pressure.

Accordingly, oxidation reaction of hydrogen occurs at the anode 14 of the fuel cell stack, generating protons and electrons. The protons and electrons thus generated move to the cathode 12 through the electrolyte membrane 10 and the separator 20, whereby water is generated at the cathode 12 through electrochemical reaction between the protons and electrons moved from the anode 14 and oxygen in the air. The electrical energy ultimately generated by this flow of electrons may be supplied to loads requiring electrical energy through current collectors connected to the end plates 30.

Meanwhile, as shown in FIG. 2, the separator 20 includes a passage section 23 configured such that a land 21, which is a flat portion that is in close contact with the gas diffusion layer 16, and a channel 22, which is a flow passage for hydrogen and air (oxygen) as a recess space between lands 21, are repeatedly formed in the width direction, and a manifold section provided in the form of a through hole in both ends of the passage section 23 for supplying and discharging air, coolant, hydrogen, etc.

The manifold section is configured to include an air supply manifold 24, a coolant supply manifold 25, and a hydrogen supply manifold 26 that are formed side by side to pass through one end of the passage section 23, and an air discharge manifold 27, a coolant discharge manifold 28, and a hydrogen discharge manifold 29 that are formed side by side to pass through the remaining end thereof.

Accordingly, gas (oxygen in the air) flowing along the channel 22 from the air supply manifold 24 of the separator 20 may diffuse into the gas diffusion layer 16 for reaction to generate electrical energy, and also gas (hydrogen) flowing along the channel 22 from the hydrogen supply manifold 26 may diffuse into the gas diffusion layer 16 for reaction to generate electrical energy.

As the channel 22 formed in the conventional separator 20 is provided in the form of a straight flow passage having a predetermined cross-sectional area, the pressure drop of the gas flowing along the channel 22 may be reduced to thus improve gas flow efficiency, but there is a disadvantage in that it does not create much gas flow in the direction (in the direction toward the gas diffusion layer in contact with the separator) perpendicular to the direction of gas flow (the direction of the gas flowing along the channel).

Moreover, since the gas flowing along the channel 22 does not flow much in the direction perpendicular to the flow direction, the amount of gas diffusion into the gas diffusion layer 16 may be reduced, and thus, gas reaction efficiency for generating electrical energy may decrease, which is undesirable.

### SUMMARY

The present disclosure relates to a separator for a fuel cell. Particular embodiments related to a separator for a fuel cell having a new structure in which partial narrow passages are formed to improve the gas reaction efficiency of a membrane-electrode assembly and also water discharge guide grooves are formed to improve water discharge performance.

Embodiments of the present disclosure keep in mind the problems encountered in the related art, and an embodiment of the present disclosure provides a separator for a fuel cell, in which channels of the separator are formed in a structure having partial narrow passages, thus increasing gas flow in the perpendicular direction where a gas diffusion layer is provided when the gas flowing along the channels passes through the partial narrow passages, thereby increasing the amount of gas diffusion into the gas diffusion layer and improving gas reaction efficiency for generating electrical energy, and in particular, water discharge guide grooves with a lowered land height are formed at both sides of the partial narrow passages, thereby preventing a phenomenon of water accumulation in the partial narrow passages and surroundings thereof and facilitating the diffusion of gas into the gas diffusion layer.

An embodiment of the present disclosure provides a separator for a fuel cell, in which a land in contact with a gas diffusion layer and a gas flow channel configured to supply gas to the gas diffusion layer are repeatedly formed in a width direction, in which partial narrow passages, which are narrow compared to a width of the channel, are formed at a predetermined interval in a longitudinal direction of the channel, and a water discharge guide groove with a lowered land height is formed at each of both lands of the partial narrow passages.

Each of the partial narrow passages may include a first narrow passage having a predetermined length that gradually narrows at a predetermined angle compared to the width of the channel and a second narrow passage having a predetermined length that gradually widens from an end of the first narrow passage to the width of the channel.

In particular, the water discharge guide groove may be provided in a form in which a land height is lowered by a preset level at both lands of the second narrow passage.

Preferably, a length of the water discharge guide groove is set to be equal to or less than a length of the second narrow passage.

Also, a depth of the water discharge guide groove may be set to be less than a difference between a thickness of the gas diffusion layer before compression and a thickness of the gas diffusion layer after compression due to fastening of the gas diffusion layer as a component of a stack.

Also, a front end and a rear end of the water discharge guide groove may be formed in a shape bent at 90°, or may be formed in a shape bent at 100° or more to prevent damage to the gas diffusion layer and increase electrical conductivity.

Also, the water discharge guide groove may be formed to be inclined from a front end to a rear end.

Preferably, an angle between the front end of the water discharge guide groove and a bottom surface of the land is set to 179° to prevent damage to the gas diffusion layer and increase electrical conductivity.

According to embodiments of the present disclosure, after the separator and the gas diffusion layer are assembled into a stack, a pore size of the gas diffusion layer in contact with the water discharge guide groove of the land may be increased compared to a pore size of the gas diffusion layer in contact with a surface of the land.

Preferably, water discharge guide grooves are formed at a predetermined interval in a longitudinal direction at both lands of the partial narrow passages, and a depth of the water discharge guide grooves formed closer to a gas discharge manifold of the separator is formed to be greater than a depth of the water discharge guide grooves formed closer to a gas supply manifold of the separator among the water discharge guide grooves.

### BRIEF DESCRIPTION OF THE DRAWINGS

The above and other features of embodiments of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 schematically shows the cell unit configuration of a fuel cell stack;

FIG. 2 is a plan view showing a conventional separator;

FIG. 3 is a plan view showing a separator for a fuel cell according to an embodiment of the present disclosure;

FIG. 4 is a partially enlarged perspective view showing a partial narrow passage formed in the channel of the separator for a fuel cell according to an embodiment of the present disclosure;

FIG. 5 is a partially enlarged perspective view showing a first embodiment of water discharge guide grooves formed at both lands of the partial narrow passage in the configuration of the separator for a fuel cell according to an embodiment of the present disclosure;

FIG. 6 is a partially enlarged plan view showing the first embodiment of the water discharge guide grooves formed at both lands of the partial narrow passage in the configuration of the separator for a fuel cell according to an embodiment of the present disclosure;

FIG. 7 is a cross-sectional view taken along the line A-A of FIG. 6 in a state where a gas diffusion layer is stacked;

FIG. 8 is a cross-sectional view taken along the line B-B of FIG. 6 in a state where the gas diffusion layer is stacked;

FIG. 9 is a partially enlarged perspective view showing a second embodiment of water discharge guide grooves formed at both lands of the partial narrow passage in the configuration of the separator for a fuel cell according to an embodiment of the present disclosure;

FIG. 10 is a partially enlarged perspective view showing a third embodiment of water discharge guide grooves formed at both lands of the partial narrow passage in the configuration of the separator for a fuel cell according to an embodiment of the present disclosure;

FIG. 11 is a cross-sectional view taken along the line C-C of FIG. 10;

FIG. 12 is a partially enlarged perspective view showing a fourth embodiment of water discharge guide grooves formed at both lands of a partial narrow passage in the configuration of the separator for a fuel cell according to an embodiment of the present disclosure; and

FIG. 13 is a cross-sectional view taken along the line D-D of FIG. 12.

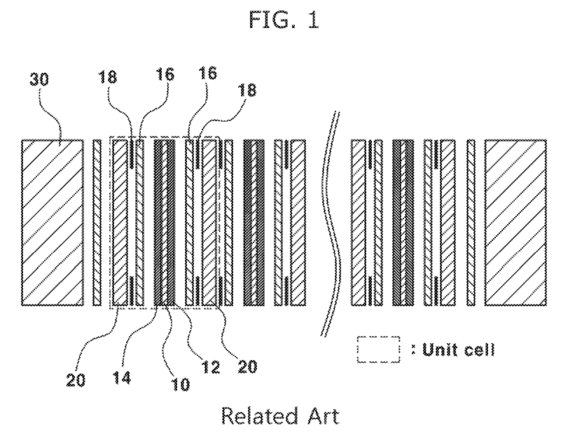

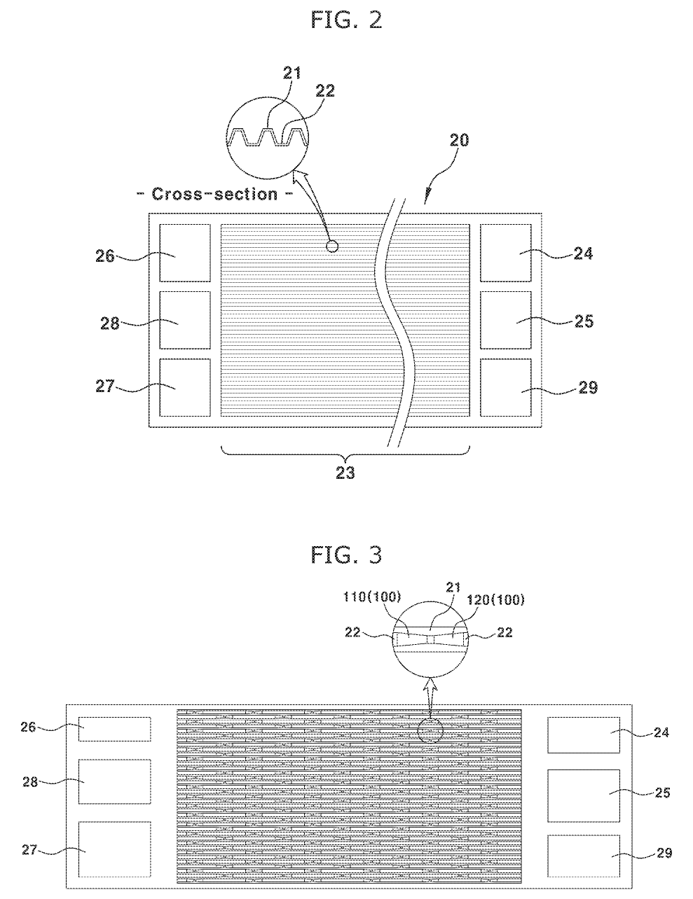

### DETAILED DESCRIPTION OF ILLUSTRATIVE EMBODIMENTS

Specific structural and functional descriptions of embodiments of the present disclosure are merely illustrative for the purpose of explaining the embodiments according to the concept of the present disclosure, and embodiments of the present disclosure may be implemented in various forms. Moreover, the embodiments of the present disclosure should not be construed as being limited to the embodiments described in this specification, and should be understood to include all changes, equivalents, and substitutes included in the spirit and technical scope of the present disclosure.

Meanwhile, it will be understood that, although terms such as “first,” “second,” etc. may be used herein to describe various elements, these elements are not to be limited by these terms. These terms are only used to distinguish one element from another element. For instance, a “first” element discussed below could be termed a “second” element without departing from the scope of the embodiments of the present disclosure. Similarly, the “second” element could also be termed a “first” element.

Throughout the specification, the same reference numerals denote the same or like elements. Meanwhile, the terms used in the present specification are intended to describe the embodiments and are not intended to limit the present disclosure. As used herein, the singular forms are intended to include the plural forms as well, unless the context clearly indicates otherwise. It will be further understood that the terms “comprises” and/or “comprising” used herein specify the presence of stated elements, steps, operations, and/or devices, but do not preclude the presence or addition of other elements, steps, operations, and/or devices.

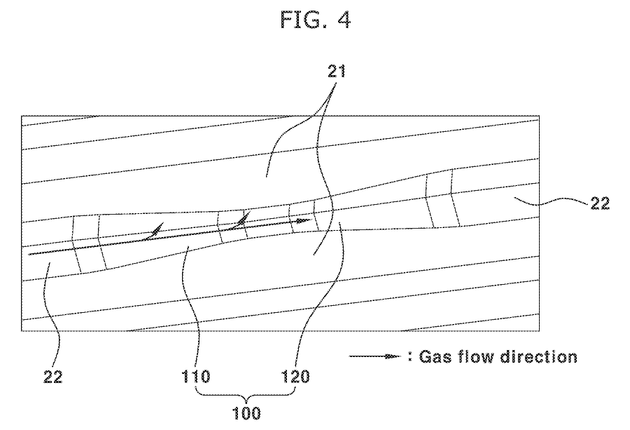

FIG. 3 is a plan view showing a separator for a fuel cell according to an embodiment of the present disclosure, and FIG. 4 is a partially enlarged perspective view showing a partial narrow passage formed in the channel of the separator for a fuel cell according to an embodiment of the present disclosure.

The separator 20 according to an embodiment of the present disclosure, as shown in FIG. 3, includes a passage section 23 in which a land 21, which is a flat portion that is in close contact with a gas diffusion layer 16, and a gas (hydrogen or air) flow channel 22 as a recess space between lands 21 are repeatedly formed in the width direction, and a manifold section provided in the form of a through hole for supplying and discharging air, coolant, hydrogen, etc. in both ends of the passage section 23.

As shown in FIG. 3, the manifold section is configured to include an air supply manifold 24, a coolant supply manifold 25, and a hydrogen supply manifold 26 that are formed side by side to pass through one end of the passage section 23, and an air discharge manifold 27, a coolant discharge manifold 28, and a hydrogen discharge manifold 29 that are formed side by side to pass through the remaining end thereof.

Accordingly, gas (oxygen in the air) flowing along the channel 22 from the air supply manifold 24 of the separator 20 may diffuse into the gas diffusion layer 16 for reaction to generate electrical energy, and also gas (hydrogen) flowing along the channel 22 from the hydrogen supply manifold 26 may diffuse into the gas diffusion layer 16 for reaction to generate electrical energy.

In particular, a partial narrow passage 100, which is narrow compared to the width of the channel 22, is formed in a portion of the total length of the channel 22.

Specifically, partial narrow passages 100, which are narrow compared to the width of the channel 22, are formed at a predetermined interval in a longitudinal direction of the channel 22.

More specifically, each of the partial narrow passages 100 is formed in a cross-sectional shape like an orifice tube, and as shown in FIG. 4, may include a first narrow passage 110 having a predetermined length that gradually narrows at a predetermined angle compared to the width of the channel 22, and a second narrow passage 120 having a predetermined length that gradually widens again from the end of the first narrow passage 110 to the width of the channel 22.

Accordingly, gas (oxygen in the air) flowing along the channel 22 including the partial narrow passages 100 from the air supply manifold 24 of the separator 20 may be supplied to the gas diffusion layer 16 for reaction to generate electrical energy, and also gas (hydrogen) flowing along the channel 22 including the partial narrow passages 100 from the hydrogen supply manifold 26 may be supplied to the gas diffusion layer for reaction to generate electrical energy.

In particular, when gas flowing along the channel 22 of the separator 20 passes through the partial narrow passages 100 each including the first narrow passage 110 and the second narrow passage 120, a lot of gas flow may occur in the direction (in the direction toward the gas diffusion layer in contact with the separator) perpendicular to the gas flow direction (the direction of the gas flowing along the channel), so that the amount of gas supplied and diffused to the gas diffusion layer may be increased, and accordingly, gas reaction efficiency for generating electrical energy may be improved.

However, when water generated during operation of the fuel cell stack flows toward the discharge manifold along the channel 22 of the separator 20, the width of the partial narrow passages 100 is less than the width of the channel 22, so that water may not be discharged but may accumulate around the partial narrow passages 100, and furthermore, the accumulated water may hinder gas from being supplied to the gas diffusion layer, which may result in a decrease in power generation efficiency of the fuel cell stack to generate electrical energy.

In order to solve this problem, water discharge guide grooves 200 with a lowered land height are formed at both lands 21 of the partial narrow passages 100.

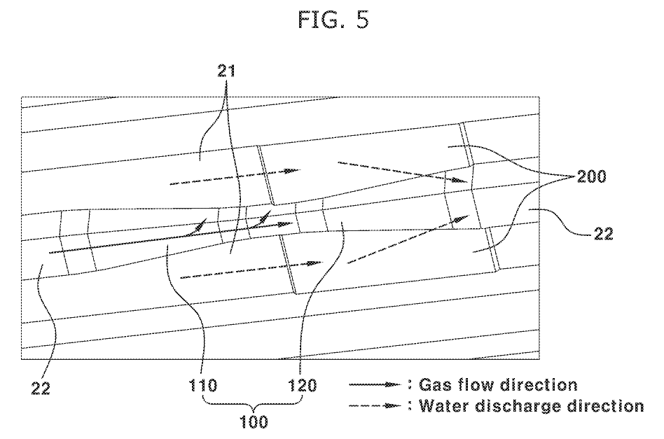

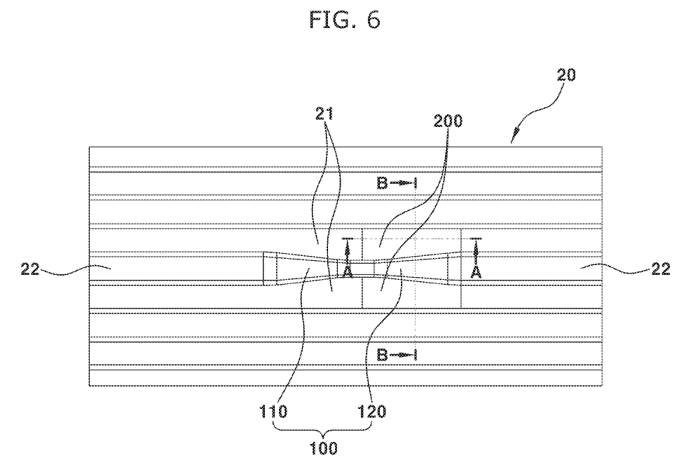

FIGS. 5 and 6 show a first embodiment of the water discharge guide grooves formed at both lands of the partial narrow passage in the configuration of the separator for a fuel cell according to an embodiment of the present disclosure.

As shown in FIGS. 5 and 6, in order to ensure efficient gas supply to the gas diffusion layer and water discharge in the partial narrow passage 100, water discharge guide grooves 200 with a lowered land height are formed at the surfaces (in contact with the gas diffusion layer) of the lands 21 arranged on both sides of the partial narrow passage 100.

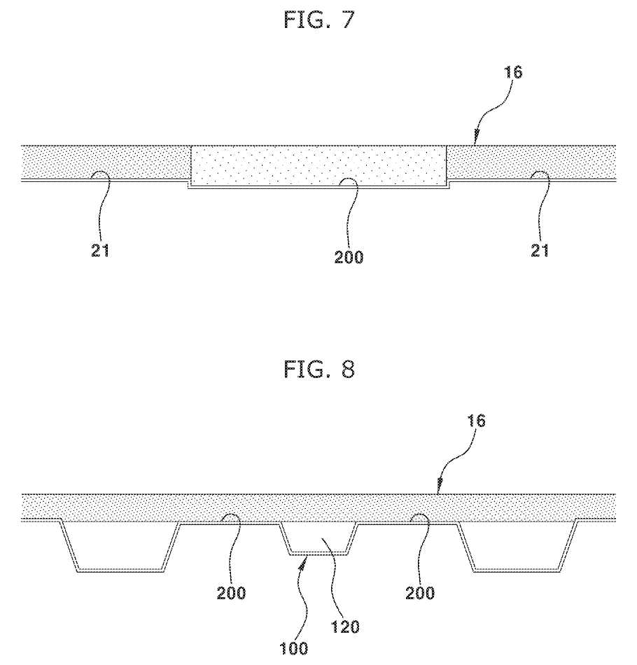

Accordingly, when the membrane-electrode assembly, the separator 20, and the gas diffusion layer 16 are assembled into a stack, as shown in FIGS. 7 and 8, not only the surface of the land 21 (the surface without the water discharge guide groove) but also the water discharge guide groove 200 may come into contact with the gas diffusion layer 16.

Here, after the separator 20 and the gas diffusion layer 16 are assembled into a stack, as shown in FIG. 8, the pore size of the gas diffusion layer 16 in contact with the water discharge guide groove 200 of the land 21 may be increased compared to the pore size of the gas diffusion layer 16 in contact with the surface of the land 21.

More specifically, when the membrane-electrode assembly, the separator 20, and the gas diffusion layer 16 are assembled into a stack by a predetermined fastening surface pressure, the fastening surface pressure applied to the gas diffusion layer 16 in contact with the water discharge guide groove 200 is less than the fastening surface pressure applied to the gas diffusion layer 16 in contact with the surface of the land 21 (the surface without the water discharge guide groove), so the pore size of the gas diffusion layer 16 in contact with the water discharge guide groove 200 of the land 21 may be increased compared to the pore size of the gas diffusion layer 16 in contact with the surface of the land 21.

When forming the water discharge guide grooves 200 with a lowered land height at both sides of the partial narrow passages 100 in this way, water accumulated in the partial narrow passages 100 and surrounding lands thereof may be efficiently discharged to the gas discharge side (hydrogen or air discharge manifold side) through the water discharge guide grooves 200, whereby water present in the land 21 and the channel 22 of the separator 20 may be easily discharged to the gas discharge manifold side, and furthermore, gas may be supplied more efficiently to the gas diffusion layer 16 due to removal of water in the channel 22 that is a factor impeding the gas flow.

In detail, water present in the lands 21 and the channels 22 of the separator 20 may seep into the water discharge guide grooves 200 and thus water may be removed from the channels 22, and by the flow pressure of the gas flowing along the channels 22, not only the water in the channels 22 but also the water present in the water discharge guide grooves 200 that communicate with the channels 22 may be easily discharged toward the gas discharge manifold.

Furthermore, by forming the water discharge guide grooves 200 with a lowered land height at both sides of the partial narrow passages 100, compressive force (fastening surface pressure) on the gas diffusion layer 16 in contact with the water discharge guide grooves 200 may be reduced, so that the pore size of the gas diffusion layer 16 in contact with the water discharge guide grooves 200 may be increased, and accordingly, water present in the pores of the gas diffusion layer may be efficiently discharged to the discharge side through the water discharge guide grooves 200, and also, gas may be supplied more efficiently to the gas diffusion layer 16.

Meanwhile, when the membrane-electrode assembly, the separator 20, and the gas diffusion layer 16 are assembled into a stack by a predetermined fastening surface pressure, contact surface pressure between the separator 20 and the gas diffusion layer 16 has to be maintained uniformly, and electrical conductivity of the gas diffusion layer 16 has to be easily obtained during operation of the stack to generate electrical energy.

Accordingly, it is preferable that the length and depth of the water discharge guide grooves 200 be set to levels capable of uniformly maintaining the contact surface pressure between the separator 20 and the gas diffusion layer 16 and also easily obtaining electrical conductivity of the gas diffusion layer 16.

To this end, the water discharge guide grooves 200 according to the first embodiment of the present disclosure may be provided in a form in which the land height is lowered by a preset level only at the surfaces of the lands 21 arranged on both sides of the second narrow passage 120 of the partial narrow passage 100, as shown in FIGS. 5 and 6, and accordingly, the length of the water discharge guide grooves 200 may be set to be equal to the length of the second narrow passage 120.

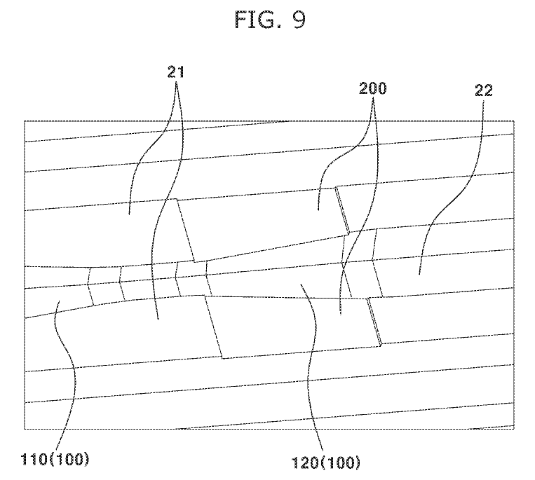

Alternatively, the water discharge guide grooves 200 according to a second embodiment of the present disclosure may be provided in a form in which the land height is lowered by a preset level only at the surfaces of the lands 21 arranged on both sides of the second narrow passage 120 of the partial narrow passage 100, as shown in FIG. 9, but the length of the water discharge guide grooves 200 may be set to be less than the length of the second narrow passage 120.

In addition, the depth of the water discharge guide grooves 200 is set to be less than a difference between the thickness of the gas diffusion layer 16 before compression and the thickness of the gas diffusion layer 16 after compression due to fastening of the gas diffusion layer 16 as a component of the stack.

As described above, by setting the length of the water discharge guide grooves 200 to be equal to or less than the length of the second narrow passage 120 and also setting the depth of the water discharge guide grooves 200 to be less than the difference in thickness of the gas diffusion layer 16 before and after compression, contact surface pressure between the separator 20 and the gas diffusion layer 16 may be uniformly maintained at a predetermined level or higher, and electrical conductivity of the gas diffusion layer 16 may be obtained at a predetermined level or higher.

Meanwhile, the front and rear ends of the water discharge guide grooves 200 according to the first and second embodiments of the present disclosure described above may be formed in a shape bent at 90° by a stamping process or the like.

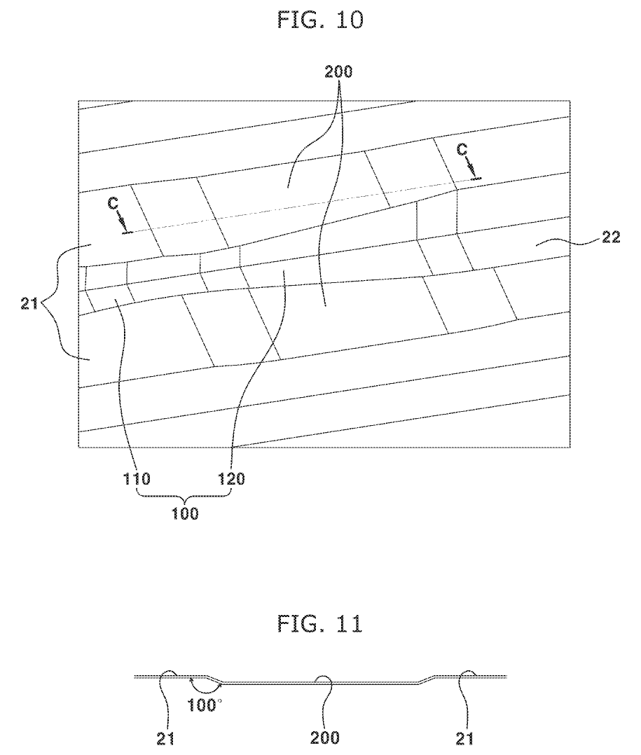

FIG. 10 is a partially enlarged perspective view showing a third embodiment of water discharge guide grooves formed at both lands of the partial narrow passage in the configuration of the separator for a fuel cell according to an embodiment of the present disclosure, and FIG. 11 is a cross-sectional view taken along the line C-C of FIG. 10.

As the front and rear ends of the water discharge guide grooves 200 according to the first and second embodiments of the present disclosure described above are formed in a shape bent at 90°, sharp edges may be formed at the front and rear ends of the water discharge guide grooves 200, and there may occur damage to the gas diffusion layer 16 that is in close contact with the water discharge guide grooves 200 due to the sharp edges.

Accordingly, the water discharge guide grooves 200 according to the third embodiment of the present disclosure are formed in a shape in which the front and rear ends are bent at 100° or more to prevent damage to the gas diffusion layer and increase electrical conductivity, as shown in FIGS. 10 and 11.

In detail, when the angle between the front and rear ends of the water discharge guide groove 200 and the bottom surface of the land 21 is set at 100° or more, the front and rear ends of the water discharge guide groove 200 may be formed as gentle slopes rather than sharp edges.

When forming the front and rear ends of the water discharge guide groove 200 as gentle slopes in this way, damage to the gas diffusion layer 16 that is in close contact with the water discharge guide grooves 200 may be prevented, and contact between the water discharge guide grooves 200 and the gas diffusion layer 16 may become more uniform, and accordingly, electrical conductivity of the gas diffusion layer 16 may be easily obtained to a predetermined level or higher.

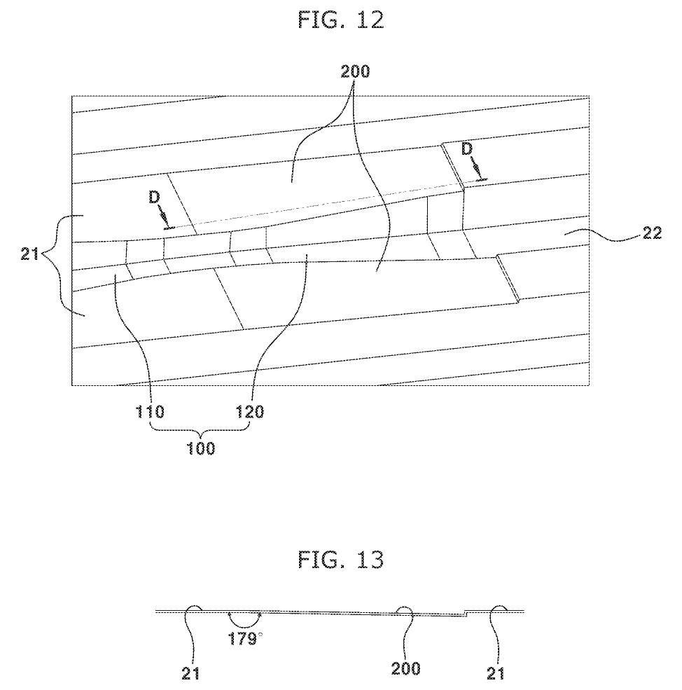

FIG. 12 is a partially enlarged perspective view showing a fourth embodiment of water discharge guide grooves formed at both lands of the partial narrow passage in the configuration of the separator for a fuel cell according to an embodiment of the present disclosure, and FIG. 13 is a cross-sectional view taken along the line D-D of FIG. 12.

The water discharge guide grooves 200 according to the fourth embodiment of the present disclosure are formed to be inclined from the front end to the rear end to increase electrical conductivity of the gas diffusion layer, as shown in FIGS. 12 and 13.

In detail, when the angle between the front end of the water discharge guide groove 200 and the bottom surface of the land 21 is set to 170 to 179°, a gentle slope may be formed from the front end of the water discharge guide groove 200 to the rear end thereof.

When the front and rear ends of the water discharge guide groove 200 are formed as a gentle slope in this way, contact between the water discharge guide grooves 200 and the gas diffusion layer 16 may become more uniform, and also close contact between the water discharge guide grooves 200 and the gas diffusion layer 16 may be increased, and accordingly, electrical conductivity of the gas diffusion layer 16 may be more easily obtained to a predetermined level or higher.

Meanwhile, depending on the characteristics and specifications of the fuel cell stack and fuel cell system, water content at each location of the separator 20 may be different.

Specifically, the water content distribution may be different along the total length of the lands 21 and the channels 22 extending from the gas supply manifold including the air supply manifold 24 and the hydrogen supply manifold 26 of the separator 20 to the gas discharge manifold including the air discharge manifold 27 and the hydrogen discharge manifold 29.

For example, with regard to the total length of the lands 21 and the channels 22, a dry phenomenon, in which there is almost no water in the lands 21 and the channels 22, may occur closer to the gas supply manifold and a flooding phenomenon, in which a large amount of water is present in the lands 21 and the channels 22, may occur closer to the gas discharge manifold.

Considering the fact that the water content differs depending on the location of the separator 20, when the depth of the water discharge guide grooves 200 formed closer to the gas discharge manifold is set to be greater than the depth of the water discharge guide grooves 200 formed closer to the gas supply manifold, the water discharge effect by the water discharge guide grooves 200 may be maximized.

More specifically, water discharge guide grooves 200 are formed at a predetermined interval in the longitudinal direction at the lands 21 arranged on both sides of the partial narrow passages 100 of the separator 20, and the depth of the water discharge guide grooves 200 formed closer to the gas discharge manifold of the separator 20 may be formed to be greater than the depth of the water discharge guide grooves 200 formed closer to the gas supply manifold of the separator 20 among the water discharge guide grooves, thereby maximizing the water discharge effect by the water discharge guide grooves 200.

As is apparent from the foregoing, embodiments of the present disclosure provides the following effects.

First, the channels of a separator are formed in a structure having partial narrow passages, thus increasing gas flow in the perpendicular direction where a gas diffusion layer is provided when the gas flowing along the channels passes through the partial narrow passages, thereby increasing the amount of gas supplied to the gas diffusion layer, ultimately improving gas reaction efficiency for generating electrical energy.

Second, water discharge guide grooves with a lowered land height are formed at both sides of the partial narrow passages, whereby water accumulated in the partial narrow passages can be efficiently discharged in the direction of gas flow through the water discharge guide grooves, thus improving water discharge performance in the channels of the separator. Also, by removing water that is a factor impeding the gas flow, the gas can be supplied more efficiently to the gas diffusion layer, ultimately improving performance of the fuel cell stack to generate electrical energy.

Third, since the water discharge guide grooves with a lowered land height are formed at both sides of the partial narrow passages, compressive force on the gas diffusion layer in contact with the water discharge guide grooves is reduced, so that the pore size of the gas diffusion layer is increased, and accordingly, the gas diffusion supply to the gas diffusion layer can become more efficient.

Although embodiments of the present disclosure have been described in detail with respect to various exemplary embodiments, the scope of the present disclosure is not limited to the embodiments described above, and various modifications and improvements made by those skilled in the art using the basic concept of the present disclosure defined in the following claims are also included in the scope of the present disclosure.

What is claimed is:

1. A separator for a fuel cell, the separator comprising:
a land in contact with a gas diffusion layer;
a gas flow channel configured to supply gas to the gas diffusion layer, wherein the land and the gas flow channel are repeatedly disposed in an alternating pattern in a width direction;
partial narrow passages disposed at a predetermined interval in a longitudinal direction of the gas flow channel, the partial narrow passages being narrow compared to a width of the gas flow channel; and
a water discharge guide groove with a lowered land height disposed at each of two lands of the partial narrow passages.

2. The separator of claim 1, wherein each of the partial narrow passages comprises:
a first narrow passage having a predetermined length that gradually narrows at a predetermined angle compared to the width of the gas flow channel; and
a second narrow passage having a predetermined length that gradually widens from an end of the first narrow passage to the width of the gas flow channel.

3. The separator of claim 2, wherein the water discharge guide groove has a form in which the land height is lowered by a preset level at lands of the second narrow passage.

4. The separator of claim 3, wherein a length of the water discharge guide groove is set to be equal to or less than a length of the second narrow passage.

5. The separator of claim 3, wherein a depth of the water discharge guide groove is less than a difference between a thickness of the gas diffusion layer before compression and a thickness of the gas diffusion layer after compression due to fastening of the gas diffusion layer as a component of a stack.

6. The separator of claim 3, wherein a front end and a rear end of the water discharge guide groove have a shape bent at 90°.

7. The separator of claim 3, wherein a front end and a rear end of the water discharge guide groove have a shape bent at 100° or more, and wherein the shape is configured to prevent damage to the gas diffusion layer and to increase electrical conductivity.

8. The separator of claim 3, wherein the water discharge guide groove is inclined from a front end to a rear end.

9. The separator of claim 8, wherein an angle between the front end of the water discharge guide groove and a bottom surface of the land is set to 170 to 179°, and wherein the angle is configured to prevent damage to the gas diffusion layer and to increase electrical conductivity.

10. The separator of claim 1, wherein, after the separator and the gas diffusion layer are assembled into a stack, a pore size of the gas diffusion layer in contact with the water discharge guide groove of the land is increased compared to a pore size of the gas diffusion layer in contact with a surface of the land.

11. The separator of claim 1, wherein:
the water discharge guide groove is disposed in plural at a predetermined interval in the longitudinal direction at the two lands of the partial narrow passages; and
a depth of the water discharge guide grooves disposed closer to a gas discharge manifold of the separator is greater than a depth of the water discharge guide grooves disposed closer to a gas supply manifold of the separator.

12. A fuel cell comprising:
a membrane-electrode assembly disposed at an innermost portion of a fuel cell stack, the membrane-electrode assembly comprising a polymer electrolyte membrane, a cathode on a first side of the polymer electrolyte membrane, and an anode on a second side of the polymer electrolyte membrane opposite the first side;
a pair of gas diffusion layers disposed at an outer surface of the cathode and an outer surface of the anode, respectively;
a pair of gaskets disposed at an outer surface of the pair of gas diffusion layers, respectively;
a pair of separators disposed at an outer surface of the pair of gaskets, respectively, wherein each of the separators comprises:
a passage section in which lands and gas flow channels are alternately arranged and repeatedly disposed in a width direction, wherein the lands are flat portions in close contact with a respective gas diffusion layer of the pair of gas diffusion layers and the gas flow channels are recess spaces disposed between the lands;
partial narrow passages disposed at a predetermined interval in a longitudinal direction of the gas flow channels, the partial narrow passages being narrow in comparison to a width of the gas flow channels;
water discharge guide grooves disposed at each of a pair of lands of each of the partial narrow passages, wherein the water discharge guide grooves have a lowered land height; and
a pair of manifold sections each having a form of a through hole and disposed in ends of the passage section, respectively.

13. The fuel cell of claim 12, wherein each of the partial narrow passages comprises:
a first narrow passage having a predetermined length that gradually narrows at a predetermined angle compared to the width of the respective gas flow channel; and
a second narrow passage having a predetermined length that gradually widens from an end of the first narrow passage to the width of the respective gas flow channel.

14. The fuel cell of claim 13, wherein each of the water discharge guide grooves has a form in which the land height is lowered by a preset level at both lands of the second narrow passage.

15. The fuel cell of claim 14, wherein a length of each of the water discharge guide grooves is set to be equal to or less than a length of the respective second narrow passage.

16. The fuel cell of claim 14, wherein a depth of each of the water discharge guide grooves is less than a difference between a thickness of the respective gas diffusion layer before compression and a thickness of the respective gas diffusion layer after compression due to fastening of the respective gas diffusion layer as a component of the fuel cell stack.

17. The fuel cell of claim 14, wherein a front end and a rear end of a first water discharge guide groove of the water discharge guide grooves have a shape bent at 90°.

18. The fuel cell of claim 14, wherein a front end and a rear end of a first water discharge guide groove of the water discharge guide grooves have a shape bent at 100° or more.

19. The fuel cell of claim 14, wherein a front end and a rear end of a first water discharge guide groove of the water discharge guide grooves have a shape designed to prevent damage to the respective gas diffusion layer and to increase electrical conductivity.

20. The fuel cell of claim 12, wherein, in a state in which the separators and the gas diffusion layers are assembled into the fuel cell stack, a pore size of the gas diffusion layers in contact with the water discharge guide grooves of the lands is increased compared to a pore size of the gas diffusion layers in contact with a surface of the lands.
